(19) United States
(12) Patent Application Publication
(10) Pub. No.: US 2013/0083950 A1
(43) Pub. Date: Apr. 4, 2013

(54) AMPLIFICATION SETTING IN A HEARING AID DEVICE

(71) Applicant: SIEMENS MEDICAL INSTRUMENTS PTE. LTD., Singapore (SG)

(72) Inventors: SEBASTIAN PAPE, ERLANGEN (DE); MAJA SERMAN, BUCKENHOF (DE)

(73) Assignee: SIEMENS MEDICAL INSTRUMENTS PTE. LTD., SINGAPORE (SG)

(21) Appl. No.: 13/632,508

(22) Filed: Oct. 1, 2012

(30) Foreign Application Priority Data
Sep. 29, 2011 (DE) 10 2011 083 736.1

(51) Int. Cl. H04R 25/00

(52) U.S. Cl. 381/316

(57) ABSTRACT

A hearing aid retains speech comprehension even during implementation of a frequency transposition. To this end, fricatives existing in an input signal prior to the frequency transposition are identified in particular with the aid of the energy distribution between the individual frequency bands. Following the frequency transposition, amplifier units are controlled in the transposed frequency bands such that a specific energy distribution existing in the non-transposed frequency bands between at least one first upper frequency band and a first lower frequency band is mapped onto a corresponding energy distribution between a second upper frequency band and a second lower frequency band of the frequency-transposed signal. This results in the fricatives obtained in the original input signal also being correctly identified following a frequency transposition.

### CROSS-REFERENCE TO RELATED APPLICATION

This application claims the priority, under 35 U.S.C. §119, of German application DE 10 2011 083 736.1, filed Sep. 29, 2011; the prior application is herewith incorporated by reference in its entirety.

### BACKGROUND OF THE INVENTION

### Field of the Invention

The invention relates to a method for processing an electrical input signal in a hearing aid device suited to implementing a frequency transposition. The invention further relates to a hearing aid device for implementing a corresponding method.

With significant hearing losses, it is frequently no longer possible to compensate for the hearing loss solely by high amplification. Hearing aid devices are therefore known in which specific frequency ranges, in which a hearing impaired person has no or almost no hearing ability, are shifted into other frequency ranges. A shift of this type is referred to as frequency transposition. A wide frequency range can be made audible again by frequency transposition, it has nevertheless been shown that the frequency transposition is only advantageous in terms of speech comprehension. In particular, so-called fricatives, which are consonants named according to their type of articulation, for instance F, S, V, Z, are frequently not understood or are understood incorrectly after a frequency transposition.

A hearing aid device suited to implementing a frequency transposition is known for instance from the German patent DE 10 2008 046 966 B3, corresponding to U.S. patent publication No 2010/0067721 A1.

A method for processing acoustic speech signals is known from international patent disclosure WO 2010/078938 A2, wherein the speech signals to be processed are divided into a number of frequency bands and the high frequency bands above a limit frequency are moved to lower frequencies below the limit frequency, and wherein the spectral energy ratios of the speech signal are detected.

### SUMMARY OF THE INVENTION

The object of the invention is to improve the speech comprehension with a hearing aid device suited to implementing a frequency transposition.

The object is achieved by a method for processing an electrical input signal in a hearing aid device with the method steps specified in the claims. Furthermore, the object is achieved by a hearing aid device for implementing a method of this type having the features according to the claims.

With the invention, an acoustic or electromagnetic input signal is initially recorded and converted by an input transducer, e.g. a microphone, into an electrical input signal. The electrical input signal is divided into a number of frequency bands (so-called channels) by a filter bank. Subsequently the energy of the electrical input signal is determined in at least two frequency bands, preferably however in all frequency bands. An energy distribution is then determined between individual frequency bands, preferably between all frequency bands. Specific fricatives contained in the input signal can be identified with the aid of the energy distribution.

Furthermore, with the inventive hearing aid device, a frequency transposition takes place, as a result of which at least one channel, in most instances in the upper frequency range, is mapped onto another, in most cases, a low lying channel. The frequency transposition generally pursues the objective of conveying or mapping a specific frequency range, e.g. 0 to 8 kHz, into another, in most instances, narrower transposed frequency range, e.g. 0 to 6 kHz. The bandwidths and limit frequencies of the transposed frequency bands, i.e. the frequency bands in the transposed frequency range, generally agree with those of the relevant original frequency bands (e.g. starting at 0 Hz: 6 frequency bands with a bandwidth of in each instance 1 kHz), only such that no transposed frequency bands exist at specific original frequency bands (e.g. at the frequency band between 6 and 7 kHz and at the frequency band between 7 and 8 kHz). It is however also possible for limit frequencies to be shifted on account of the frequency transposition, so that 8 frequency bands between 0 and 8 kHz are mapped to 8 frequency bands between 0 and 6 kHz for instance. Hybrid types are also possible, in which both the limit frequencies and also the number of frequency bands vary between the original frequency range and the transposed frequency range.

In most cases a number of frequency bands are mapped (shifted) into other frequency bands with a hearing aid device suited to implementing a frequency transposition. Specific frequency bands, in most cases in the lower frequency range, are frequently also not affected by the frequency transposition, i.e. both the limit frequencies of the relevant frequency bands and also the signal components of an input signal are the same in these frequency bands prior to and after the frequency transposition.

With an inventive hearing aid device, at least one amplifier unit furthermore exists, by which the amplification in a specific frequency band, in particular in a specific frequency band affected by the frequency transposition, can be adjusted individually. An amplifier unit of this type is preferably provided for each frequency band in the transposed frequency range. According to the invention, the amplification is set as a function of the previously determined energy distribution.

The invention is advantageous in that by controlling the amplification in individual frequency bands, an energy distribution existing between at least two frequency bands prior to the transposition can be mapped onto the transposed frequency bands, in other words a corresponding energy distribution between two frequency bands (of the transposed frequency range) exists even after the frequency transposition. This is achieved in that speech components existing in the input signal also remain understandable after the frequency transposition and fricatives existing in the input signal are in particular correctly identified.

The invention provides in particular to map a ratio of the energy distribution between a first upper frequency band and a first lower frequency band prior to the frequency transposition into a corresponding ratio between a second upper frequency band and a second lower frequency band following the frequency transposition. As a result, it is possible in particular to prevent specific fricatives from being mistaken for other fricatives after the frequency transposition.

Other features which are considered as characteristic for the invention are set forth in the appended claims.

Although the invention is illustrated and described herein as embodied in an amplification setting in a hearing aid device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flowchart for implementing a method according to the invention; and

FIG. 2 is a block diagram of a hearing aid device to implement the inventive method.

### DETAILED DESCRIPTION OF THE INVENTION

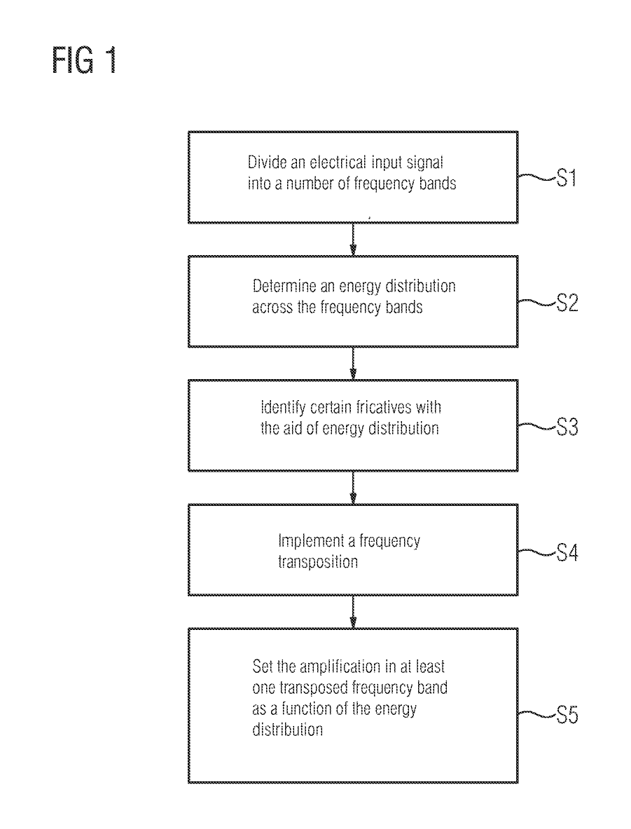

According to FIG. 1, during the course of an inventive method, an electric input signal is initially divided into a number of frequency bands in method step S1. A division into eight frequency bands is usual for instance. Another division, in particular a finer division with a significantly larger number of frequency bands is however also possible.

An energy distribution between the frequency bands is determined in a second method step S2. In this process it is also possible, particularly with a large number of frequency bands, to combine a number of frequency bands in order to determine the energy distribution respectively.

Specific fricatives can be identified and differentiated in method step S3 with the aid of the energy distribution across individual frequency bands and in particular with the aid of the ratio of the energy in a specific upper frequency band and a specific lower frequency band.

Finally, a frequency transposition is implemented in method step S4. Specific frequency bands are preferably mapped here onto specific other frequency bands as a function of the individual hearing loss of a test person. It can also be stated that a specific frequency range is mapped and/or shifted into a transposed frequency range.

Since not all frequency bands are generally affected to the same degree by a frequency transposition, the previously existing energy distribution between the upper and lower frequency bands is frequently destroyed by the frequency transposition. Fricatives existing in the original input signal can as a result no longer be correctly identified. The invention therefore provides in method step S5 to set the amplification in at least one transposed frequency band as a function of the determined energy distribution in the original frequency bands. Here the amplification is set such that an energy distribution existing in the original frequency bands between at least a first upper frequency band and a first lower frequency band exists at least essentially also in the energy distribution between a second upper transposed frequency band and a second lower transposed frequency band. As a result, the invention enables the fricative existing in the original input signal and which can be identified with the aid of the energy distribution to still also be perceivable as the same fricative after the frequency transposition. The comprehensibility of a speech signal obtained in the input signal is also retained following the frequency transposition.

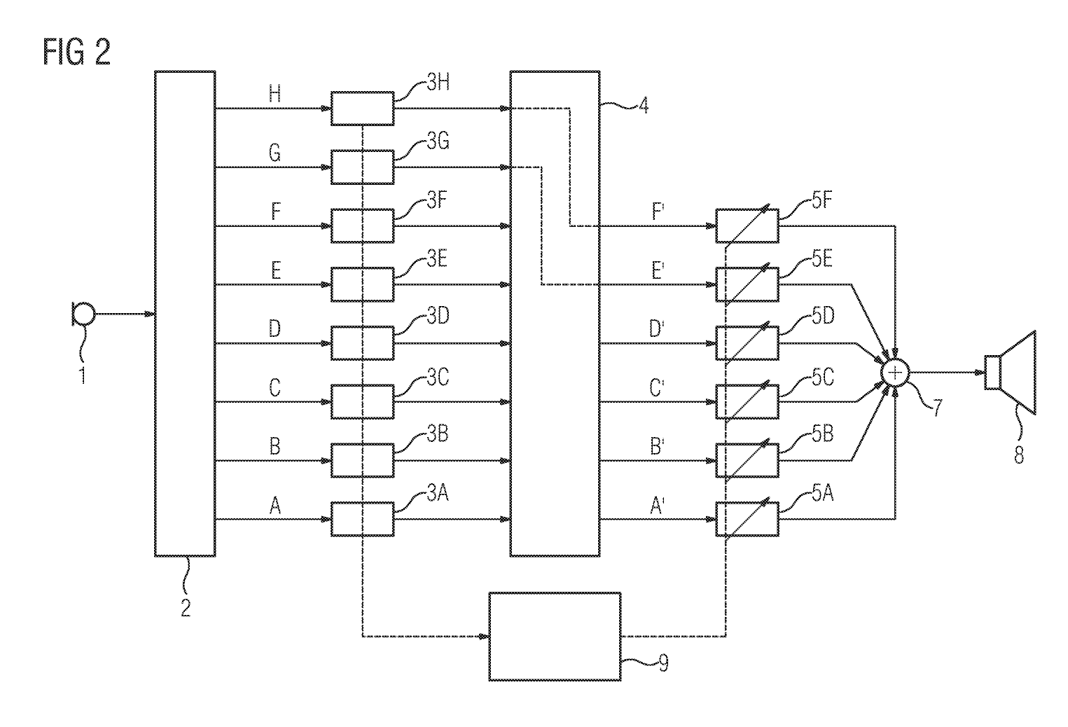

FIG. 2 shows a hearing aid device according to the invention in a very simplified block diagram. A microphone 1 records an acoustic input signal and converts the signal into an electrical input signal, which is initially fed to a filter bank 2. The filter bank 2 divides the electrical input signal into eight frequency bands A to H. An energy determination unit 3A and/or 3B and/or 3C . . . and/or 3H exists in each frequency band A to H, by which the energy of the electrical input signal is determined in the respective frequency band. The thus determined values of the energy in the respective frequency bands are fed to a signal processing and control unit 9. This determines an energy distribution between the individual frequency bands from the individual energy values, with the aid of which specific fricatives existing in the input signal can be identified. The signals of the individual frequency bands are furthermore fed to a frequency transposition unit 4, by which the specific frequency bands are moved (transposed) to other frequency bands. In the exemplary embodiment, the 8 frequency bands A to H originally existing are conveyed to 6 transposed frequency bands A′ to F′, wherein the lower 4 frequency bands A to D remain unaffected by the frequency transposition, i.e. the original frequency bands A to D agree with the transposed frequency bands A′ to D′, both in respect of the limit frequencies and also in respect of the electrical signal in the respective frequency band. In the exemplary embodiment, the original 7^{th} frequency band G is also conveyed to the 5^{th} transposed frequency band E′ and the originally existing 8^{th} frequency band H is conveyed to the 6^{th} transposed frequency band F′.

The electrical signals in the transposed frequency bands A′ to F′ are finally merged in an adder 7 and fed as an electrical output signal to a receiver 8, which converts the electrical output signal into an acoustic output signal.

The inventive hearing aid device also includes an amplifier unit 5A and/or 5B and/or . . . 5F in each transposed frequency band, the amplification of which can be set individually by the signal processing and control unit 9. Since both the energy in the individual frequency bands prior to the frequency transposition and also the frequency transposition rule are known, it is possible to set the amplifier units 5A to 5F such that an energy distribution existing in the frequency bands prior to the frequency transposition between at least a first upper frequency band (e.g. G) and a first lower frequency band (e.g. D) is retained at a corresponding energy distribution between at least one second upper frequency band (e.g. E′) and a second lower frequency band (e.g. D′) in the transposed frequency bands. It would alternatively also be possible to directly measure the energy of the signal components in the transposed frequency bands (not shown) and to set the amplifier units 5A to 5F accordingly in order to reach a specific energy distribution by corresponding energy determination units in the transposed frequency bands.

By means of the invention, fricatives obtained in the input signal remain perceivable overall as the original fricative even after the frequency transposition into the generated output signal. It therefore contributes to improving the speech comprehension when implementing a frequency transposition.

1. A method for processing an electrical input signal in a hearing aid device, which comprises the following steps:
dividing the electrical input signal into a number of frequency bands;
determining an energy of the electrical input signal in at least two of the frequency bands and an energy distribution between the at least two frequency bands respectively;
identifying specific fricatives with an aid of the energy distribution;
performing a frequency transposition;
setting an amplification in at least one transposed frequency band in dependence on an action of the energy distribution determined; and
mapping a ratio of the energy distribution between a first upper frequency band and a first lower frequency band prior to the frequency transposition into a corresponding ratio between a second upper frequency band and a second lower frequency band following the frequency transposition.

2. A hearing aid device, comprising:
an input transducer for recording an acoustic input signal and converting the acoustic input signal into an electrical input signal;
a filter bank for dividing the electrical input signal into a number of frequency bands;
energy determination units for determining a respective energy of the electrical input signal in individual ones of the frequency bands;
a frequency transposition unit for performing a frequency transposition;
amplifier units for setting an amplification of transposed frequency bands;
a signal processing and control unit for determining an energy distribution between individual ones of the frequency bands and to control the amplification in the transposed frequency bands in dependence on the energy distribution determined;
an adder for merging signals in the transposed frequency bands and for generating an electrical output signal; and
an output transducer for converting the electrical output signal into an output signal which can be perceived as an acoustic output signal by a user.

3. The hearing aid device according to claim 2, wherein a ratio of the energy distribution between a first upper frequency band and a first lower frequency band can be determined prior to the frequency transposition and can be mapped into a corresponding ratio between a second upper frequency band and a second lower frequency band following the frequency transposition.

4. The hearing aid device according to claim 2, wherein the transposed frequency bands agree with original frequency bands in respect of their bandwidths and limit frequencies.
